(19) United States
(12) Patent Application Publication
(10) Pub. No.: US 2026/0001034 A1
(43) Pub. Date: Jan. 1, 2026

(54) HIGH-EFFICIENCY CARBON DIOXIDE (CO2) CAPTURE CERAMIC FILTRATION SYSTEM AND APPLICATION METHOD THEREOF

(71) Applicants: HSU-LING PENG, TAIPEI (TW); TSUNG-WEI LIN, TAIPEI (TW)

(72) Inventors: HSU-LING PENG, TAIPEI (TW); TSUNG-WEI LIN, TAIPEI (TW)

(21) Appl. No.: 18/759,842

(22) Filed: Jun. 29, 2024

(51) Int. Cl. B01D 53/62; B01D 53/04; B01D 53/82; B01J 20/04; B01J 20/20; B01J 20/30

(52) U.S. Cl. CPC B01D 53/62; B01D 53/0407; B01D 53/82; B01J 20/041; B01J 20/20; B01J 20/3007; B01J 20/3021; B01J 20/3078; B01D 2251/404; B01D 2251/602; B01D 2253/102; B01D 2253/34; B01D 2257/504; B01D 2258/01; B01D 2258/02

(57) ABSTRACT

The present invention relates to a high-efficiency carbon dioxide (CO₂) capture ceramic filtration system and its application method. The system includes a carbon capture exhaust pipe configured to store a CO₂ capture material. The key materials of the CO₂ capture material are dolomite powder, coral powder, shell powder combined with pottery clay, clay, coffee grounds, and activated carbon with the porous structure and plasticity. It constitutes a low-cost, high-efficiency filter material rich in calcium oxide for carbon dioxide capture, which can be effectively activated at low temperatures. Through the moisture generated during combustion, calcium oxide is converted into calcium hydroxide while capturing the carbon dioxide produced during the combustion. The overall application does not require additional construction of other complex filtration devices to achieve high-efficiency carbon dioxide capture rates. It can contribute to reducing carbon emissions and has extensive potential for achieving sustainable development of environmental protection.

### FIELD OF THE INVENTION

The present invention relates to the field of carbon dioxide treatment, specifically to a high-efficiency carbon dioxide capture ceramic filtration system and an application method thereof.

### BACKGROUND OF THE INVENTION

With the development of industry and changes in human living habits, the concentration of carbon dioxide (CO₂) in the atmosphere is continuously rising. Research by the National Oceanic and Atmospheric Administration (NOAA) in the United States has found that the increase in CO₂ concentration is positively correlated with the rise in surface temperatures. This situation has led to the disintegration of ice sheets, climate change and ecological crises. Therefore, effective carbon management strategies are crucial.

Since the industrial revolution, human activities such as deforestation and burning fossil fuels have significantly increased CO₂ emissions. Greenhouse gases absorb and re-radiate infrared radiation in the atmosphere, leading to global warming and climate change. This results in rising temperatures and melting glaciers, which cause sea levels to rise, posing a severe threat to low-lying areas and island nations. Additionally, temperature changes affect ecosystems and species distribution, with many species facing habitat loss and the risk of extinction.

Additionally, high concentrations of CO₂ impact the chemical properties of oceans, leading to ocean acidification. Acidified ocean is detrimental to marine life such as corals and shellfish, disrupting the balance of marine ecosystems and subsequently affecting fisheries and related economic activities.

To address the environmental impact of CO₂ emissions, countries around the world are actively promoting carbon reduction policies and technological innovations. These measures include improving energy efficiency, developing renewable energy sources (such as wind and solar power), promoting electric vehicles, and advancing carbon capture and storage technologies.

In the current technologies, post-combustion capture is the most commonly used technique. This method captures CO₂ by using absorbents, such as ethanolamine, after the combustion process. The captured CO₂ is then separated and stored. However, this technique is mainly applicable to coal-fired or natural gas power plants due to the high volume of gas emissions and the low partial pressure of CO₂. As a result, the technique requires large absorption and stripping towers, which increase the cost. Additionally, ethanolamine solutions are alkaline, and high concentrations may corrode equipment, thus there are certain concentration limitations in its use.

### SUMMARY OF THE INVENTION

The purpose of this invention is to address the deficiencies of the existing technology by providing an application method of a high-efficiency carbon dioxide capture ceramic filtration system, including constructing a carbon capture exhaust pipe having an accommodating space therein for placing a carbon dioxide capture material, wherein a front end of the accommodating space is connected to an inlet to integrate with an exhaust port of a combustion heating treatment device, a rear end of the accommodating space is connected to an outlet for exhaust to an outside, a carbon dioxide capturing method includes the following steps.

Producing the carbon dioxide capture materials by mixing dolomite powder, coral powder, shell powder with pottery clay, clay, coffee grounds and activated carbon, and sintering to obtaining a porous structure rich in the calcium oxide.

Filling the accommodating space of the carbon capture exhaust pipe with the carbon dioxide capture materials, wherein gaps are in between each carbon dioxide capture material.

Installing the carbon capture exhaust pipe onto the combustion heating treatment device, wherein the inlet is connected to an exhaust port of the combustion heating treatment device to exhaust to the outside through the outlet.

Converting calcium oxide into calcium hydroxide by moisture, generated by a combustion of the combustion heating treatment device, being captured the carbon dioxide capture materials, wherein the carbon dioxide produced during the combustion of the combustion heating treatment device is captured.

Preferably, the combustion heating treatment device is configured to be as household water heaters, range hood exhaust ducts, thermal power plants. However, the present disclosure is not limited thereto.

Preferably, the carbon dioxide capture material is in the form of strip ceramics, granular ceramics, or cylindrical ceramics with air channels. However, the present disclosure is not limited thereto.

Preferably, the carbon dioxide capture material consists of dolomite powder, coral powder, shell powder with pottery clay, clay, coffee grounds and activated carbon, mixed in proportion.

Compared with the existing conventional technologies, the practical advantages of this disclosure lie in the use of major materials for carbon dioxide capture, including mixing and sintering dolomite powder, coral powder, shell powder, pottery clay, clay, coffee grounds, activated carbon to have the porous structure and plasticity characteristics. It constitutes a low-cost, high-efficiency filter material rich in calcium oxide for carbon dioxide capture, which can be effectively activated at low temperatures. Through the moisture generated during combustion, calcium oxide is converted into calcium hydroxide while capturing the carbon dioxide produced during the combustion. The overall application does not require additional construction of other complex filtration devices to achieve high carbon dioxide capture rates. This technology is applicable to various products, such as vehicle exhaust pipes, household water heaters, range hood exhaust ducts, and thermal power plants. It can contribute to reducing carbon emissions and has extensive potential for achieving sustainable development of environmental protection.

### BRIEF DESCRIPTION OF THE DRAWINGS

FIG. 1 is a schematic diagram of the carbon capture exhaust pipe in one embodiment of the present disclosure.

FIG. 2 is an application example of the carbon capture exhaust pipe in one embodiment of the present disclosure.

FIGS. 3A, 3B and 3C are schematic diagrams of the carbon dioxide capture material in one embodiment of the present disclosure.

FIG. 4 is a schematic diagram illustrating the carbon capture exhaust pipe designed in a cylindrical shape in one embodiment of the present disclosure.

FIG. 5 is a schematic diagram illustrating the carbon capture exhaust pipe designed in a round-block-shape in one embodiment of the present disclosure.

FIG. 6 is a schematic diagram illustrating the carbon capture exhaust pipe equipped with the enlarged hood in one embodiment of the present disclosure.

FIG. 7 is a flowchart of the application method in one embodiment of the present disclosure.

FIG. 8 is a pH testing chart of the carbon dioxide capture material in one embodiment of the present disclosure.

FIG. 9 is a Carbon dioxide concentration detection chart in one embodiment of the present disclosure.

### DETAILED DESCRIPTION OF THE INVENTION

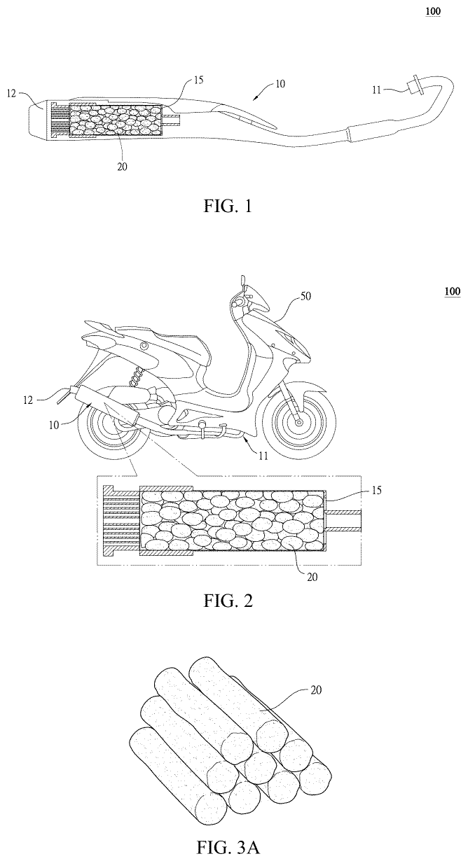

For a better understanding of the content and effectiveness of the present invention, specific embodiments are listed in conjunction with the drawings to illustrate the details as follows. Please refer to FIG. 1 and FIG. 2, the high-efficiency carbon dioxide capture ceramic filtration system 100 includes a carbon capture exhaust pipe 10 having an accommodating space 15 therein for placing a carbon dioxide capture material 20. The front end of the accommodating space 15 is connected to an inlet 11 to integrate with the exhaust port of a combustion heating treatment device 50. The rear end of the accommodating space 15 is connected to an outlet 12 for exhaust to the outside.

The carbon dioxide capture material 20 is a porous structure, rich in calcium oxide (CaO), formed by mixing dolomite powder, coral powder, shell powder with pottery clay, clay, coffee grounds and activated carbon, and then sintering the mixture.

In one embodiment, for example, the combustion heating treatment device 50 is a motorcycle, and the carbon capture exhaust pipe 10 is a vehicle exhaust pipe. However, the present disclosure is not limited thereto.

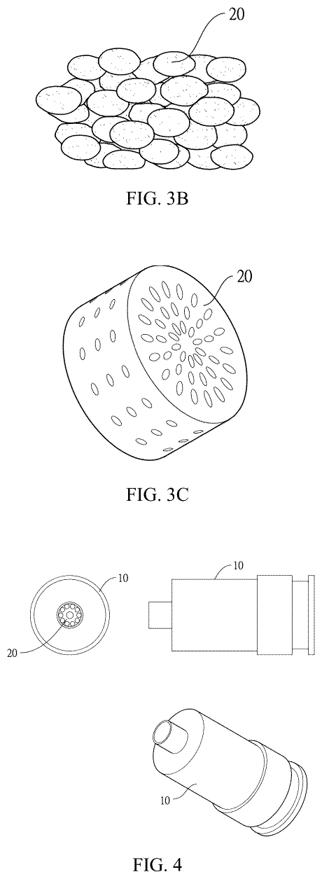

In one embodiment, as shown in FIGS. 3A, 3B and 3C, the carbon dioxide capture material 20 is in the form of strip ceramics, granular ceramics, or cylindrical ceramics with air channels. However, the present disclosure is not limited thereto.

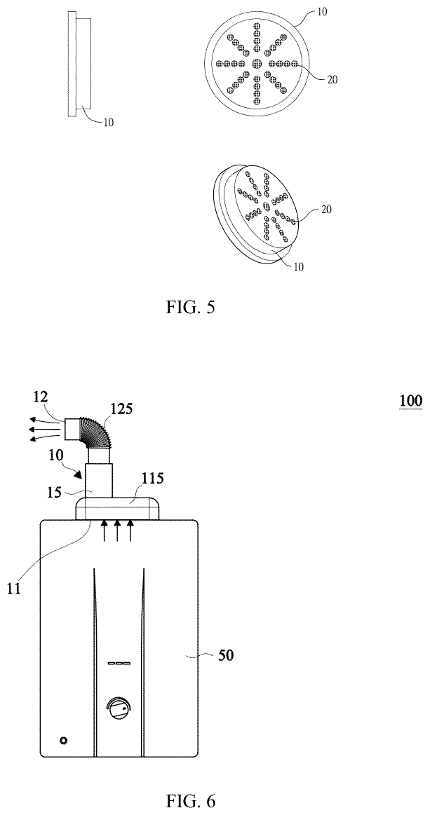

In one embodiment, as shown in FIGS. 4 and 5, the present disclosure can also be designed based on the same principle to have different appearances for the carbon capture exhaust pipe 10, such as cylindrical or round-block-shaped structures, to meet customized requirements or for the use with different equipment, such as household water heaters, range hood exhaust ducts, thermal power plants, or other equipment (Not shown in the figure).

In one embodiment, as shown in FIG. 6, in order to accommodate the specific needs of other customized combustion heating treatment devices 50, such as for household water heaters, the carbon capture exhaust pipe 10 may have an enlarged hood 115 configured in front of the inlet 11 to facilitate the collection of carbon dioxide from combustion air. Additionally, a bellows duct 125 may be configured between the outlet 12 and the accommodating space 15 to facilitate bending according to spatial planning to discharge the filtered air. However, the present disclosure is not limited thereto.

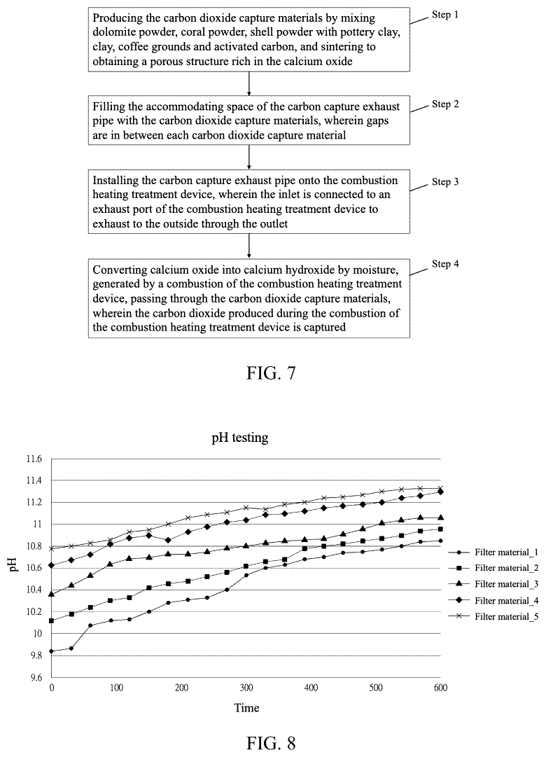

As shown in FIG. 1 to FIG. 7, the application method of the high-efficiency carbon dioxide capture ceramic filtration system includes the following steps.

Constructing the carbon capture exhaust pipe 10 having the accommodating space 15 therein for placing the carbon dioxide capture materials 20, wherein the front end of the accommodating space 15 is connected to the inlet 11 to integrate with the exhaust port of the combustion heating treatment device 50, the rear end of the accommodating space 15 is connected to the outlet 12 for exhaust to the outside. And the following method is executed for carbon dioxide capture.

In step 1, producing the carbon dioxide capture material 20. Mixing dolomite powder, coral powder, shell powder with pottery clay, clay, coffee grounds and activated carbon, and sintering to obtaining the porous structure rich in the calcium oxide.

In step 2, filling the accommodating space 15 of the carbon capture exhaust pipe 10 with the carbon dioxide capture materials 20, wherein gaps are in between each carbon dioxide capture material.

In step 3, installing the carbon capture exhaust pipe 10 onto the combustion heating treatment device 50, wherein the inlet 11 is connected to the exhaust port of the combustion heating treatment device 50 to exhaust to the outside through the outlet 12.

In step 4, converting calcium oxide into calcium hydroxide by the moisture, generated by the combustion of the combustion heating treatment device 50, being captured the carbon dioxide capture material 20. Simultaneously, the carbon dioxide produced during the combustion of the combustion heating treatment device 50 can be effectively captured.

In one embodiment, the ratio of the dolomite powder, the coral powder, the shell powder, and the pottery clay, the clay, the coffee grounds, the activated carbon, within the carbon dioxide capture material 20, is 1:1. However, the present disclosure is not limited thereto.

In one embodiment, the specific producing process of the carbon dioxide capture material 20 includes grinding the dolomite powder, the coral powder, and the shell powder, and then calcining the grinded dolomite powder, coral powder, and shell powder by multiple stages of heating parameters. Cooling to room temperature by furnace cooling. Then, mixing the heat-treated dolomite powder, coral powder, shell powder with pottery clay, clay, coffee grounds, activated carbon and water. Forming into shape. Preforming a heat treatment with multiple stages of heating parameters. Finally, cooling to room temperature by furnace cooling.

The detailed process for producing the carbon dioxide capture material 20 of the present disclosure is as follows.

First, collecting the dolomite, the coral, and the shells, cleaning thoroughly to remove the residues and the organisms, then drying. Next, grinding the dolomite, the coral, and the shells into the dolomite powder, the coral powder, and the shell powder using suitable equipment.

In one embodiment, the dolomite powder, coral powder, and shell powder are subjected to calcination by sequential stages of heating parameters at 80° C. for 1 hour, 200° C. for 1 hour, and 1000° C. for 1 hour.

Pottery clay, clay, coffee grounds, and activated carbon materials, with optimal blending ability, are selected. For example, a suitable ratio, such as 1:1, may be adopted, but the present disclosure is not limited thereto. Mixing the dolomite powder, coral powder, and shell powder with the pottery clay, the clay, the coffee grounds, and the activated carbon, and ensuring the even distribution of the materials.

In one embodiment, mixing the heat-treated dolomite powder, coral powder, and shell powder with the pottery clay, the clay, the coffee grounds and the activated carbon, adding water, then forming the shape. Subsequently, drying and removing the moisture by sequential heat treatment stages of heating parameters at 40° C. for 15 minutes to 1 hour, 60° C. for 15 minutes to 1 hour, 80° C. for 30 minutes to 1 hour, 200° C. for 1 hour, and 1000° C. for 1 hour. Then, calcining at high temperature to convert calcium carbonate (CaCO₃), which is the main ingredient of the dolomite powder, the coral powder, and the shell powder, into calcium oxide, which is capable of capturing carbon dioxide.

The technical advantages of the present disclosure are as follows.

The materials used in the present disclosure include the dolomite powder, the coral powder, the shell powder, combined with the pottery clay, the clay, the coffee grounds, and the activated carbon. These materials offer advantages of low cost, high efficiency, and promote a “circular economy” approach.

The proportion of the dolomite powder, the coral powder, and the shell powder can be appropriately increased. By processing the filter material through heat treatment, the internal moisture can slowly diffuse to the surface, thereby the filter material may be shaped without cracking.

The dolomite powder, coral powder, and shell powder, which are natural materials rich in calcium oxide, can generate calcium hydroxide during combustion. Calcium hydroxide reacts with carbon dioxide to form calcium carbonate. On the other hand, pottery clay, clay, coffee grounds, and activated carbon provide a porous structure, enhancing capture efficiency, with activated carbon has excellent adsorption properties. This allows the carbon dioxide capture material 20 to convert calcium oxide into calcium hydroxide at room temperature, achieving the effect of low-temperature triggering. As shown in FIG. 8, FIG. 8 illustrates the pH test results after placing 10 grams to 50 grams of carbon dioxide capture material 20 into 100 milliliters of deionized water for filter materials.

When applying, as shown in FIG. 1, the carbon dioxide capture material 20 is shaped into appropriate sizes and processed into strip or granular ceramic filters after heat treatment. These filters are then filled into the accommodating space 15 of the carbon capture exhaust pipe 10. The carbon capture exhaust pipe 10 is installed on the motorcycle exhaust pipe, with the inlet 11 connected to the motorcycle's exhaust port, and the outlet 12 allowing exhaust to the outside. In this setup, when the motorcycle emits exhaust gases, the calcium oxide is converted into calcium hydroxide at room temperature, thereby achieving the effect of low-temperature triggering. This process effectively captures the carbon dioxide generated during the combustion and locks the carbon dioxide in the carbon dioxide capture material 20. The captured and converted exhaust gases can then be discharged to the outside through the outlet 12.

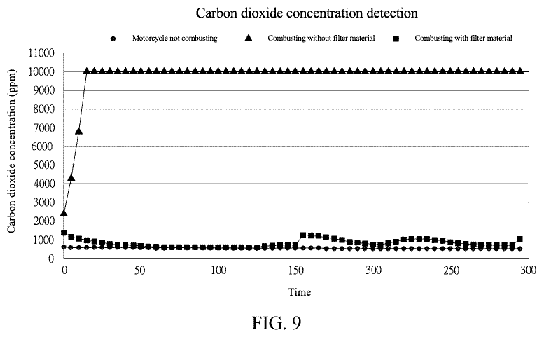

As shown in FIG. 9, the measured data from the application system of the present disclosure demonstrates that when a motorcycle is equipped with the carbon capture exhaust pipe 10 containing the carbon dioxide capture material 20, and the emission of carbon dioxide is measured during combustion. The result indicates that the technology of the present disclosure achieves a higher carbon dioxide capture rate (96.03%) at typical motorcycle exhaust operating temperatures (65 to 80 degrees). The result shows the present disclosure can make the emission of motorcycle exhaust more environmentally friendly and can effectively remove carbon dioxide, thereby reducing the burden of the atmosphere.

The operation of the system of the present disclosure is straightforward, requiring no complex control or specialized skills. It can be easily assembled onto motorcycles and requires no additional maintenance during regular operation, making it highly suitable for widespread adoption. The system has efficient carbon dioxide capture capabilities, not only reducing carbon emissions but also converting them into useful substances. After the carbon dioxide capture material 20 is used, the heat treatment may be performed to convert it back into calcium oxide and carbon dioxide. This process is cyclical, enabling long-term carbon dioxide capturing and recycling. The recycled carbon dioxide can be utilized in carbon cycling technologies, transforming it into useful chemicals and fuels, such as synthetic fuels, methanol, and ethylene, thereby reducing dependence on fossil fuels. Or it can also be used in the beverage and food industries for carbonated drinks and food products, or to adjust the pH value of water to improve water quality, and even for medical purposes or rocket propulsion.

Compared with the existing conventional technologies, the practical advantages of this disclosure lie in the use of major materials for carbon dioxide capture, including mixing and sintering dolomite powder, coral powder, shell powder, pottery clay, clay, coffee grounds, activated carbon to have the porous structure and plasticity characteristics. It constitutes a low-cost, high-efficiency filter material rich in calcium oxide for carbon dioxide capture, which can be effectively activated at low temperatures. Through the moisture generated during combustion, calcium oxide is converted into calcium hydroxide while capturing the carbon dioxide produced during the combustion. The overall application does not require additional construction of other complex filtration devices to achieve high carbon dioxide capture rate. This technology is applicable to various products, such as vehicle exhaust pipes, household water heaters, range hood exhaust ducts, and thermal power plants. It can contribute to reducing carbon emissions and has extensive potential for achieving sustainable development of environmental protection.

In summary, the present invention is novel and practical, fully meeting the requirements for patentability. Therefore, a patent application is proposed. However, the embodiments described above are merely preferable implementations of the present invention and should not limit the scope of the invention. Hence, any equivalent changes and modifications made according to the scope of the patent application and the contents of the specification should be within the scope of the patent coverage of the present invention.

What is claimed is:

1. A high-efficiency carbon dioxide capture ceramic filtration system, comprising:
a carbon capture exhaust pipe having an accommodating space therein for placing a carbon dioxide capture material;
wherein a front end of the accommodating space is connected to an inlet to integrate with an exhaust port of a combustion heating treatment device, a rear end of the accommodating space is connected to an outlet for exhaust to an outside, the carbon dioxide capture material is a porous structure, rich in calcium oxide, formed by mixing and sintering dolomite powder, coral powder, shell powder with pottery clay, clay, coffee grounds, and activated carbon.

2. The high-efficiency carbon dioxide capture ceramic filtration system according to claim 1, wherein the carbon dioxide capture material is in forms of strip ceramics, granular ceramics, or cylindrical ceramics with air channels.

3. The high-efficiency carbon dioxide capture ceramic filtration system according to claim 1, wherein the combustion heating treatment device is a household water heater, an enlarged hood is configured between the front end of the accommodating space and the inlet, and an air duct is configured between the outlet and the accommodating space.

4. A application method of a high-efficiency carbon dioxide capture ceramic filtration system, comprising; constructing a carbon capture exhaust pipe having an accommodating space therein for placing a carbon dioxide capture material, wherein a front end of the accommodating space is connected to an inlet to integrate with an exhaust port of a combustion heating treatment device, a rear end of the accommodating space is connected to an outlet for exhaust to an outside, and a carbon dioxide capturing method comprises:
producing the carbon dioxide capture materials by mixing dolomite powder, coral powder, shell powder with pottery clay, clay, coffee grounds and activated carbon, and sintering to obtaining a porous structure rich in the calcium oxide;
filling the accommodating space of the carbon capture exhaust pipe with the carbon dioxide capture materials, wherein gaps are in between each carbon dioxide capture material;
installing the carbon capture exhaust pipe onto the combustion heating treatment device, wherein the inlet is connected to an exhaust port of the combustion heating treatment device to exhaust to the outside through the outlet;
converting calcium oxide into calcium hydroxide by moisture, generated by a combustion of the combustion heating treatment device, being captured by the carbon dioxide capture materials, wherein the carbon dioxide produced during the combustion of the combustion heating treatment device is captured.

5. The application method of a high-efficiency carbon dioxide capture ceramic filtration system according to claim 4, wherein the combustion heating treatment device is a motorcycle.

6. The application method of a high-efficiency carbon dioxide capture ceramic filtration system according to claim 4, wherein the carbon dioxide capture material is in forms of strip ceramics, granular ceramics, or cylindrical ceramics with air channels.

7. The application method of a high-efficiency carbon dioxide capture ceramic filtration system according to claim 4, wherein a ratio of the dolomite powder, the coral powder, the shell powder, and the pottery clay, the clay, the coffee grounds, the activated carbon, within the carbon dioxide capture material, is 1:1.

8. The application method of a high-efficiency carbon dioxide capture ceramic filtration system according to claim 7, wherein a producing method of the carbon dioxide capture material comprises:
grinding the dolomite powder, the coral powder, and the shell powder;
calcining the grinded dolomite powder, coral powder, and shell powder by multiple stages of heating parameters;
cooling to room temperature by furnace cooling;
mixing the heat-treated dolomite powder, coral powder, shell powder with pottery clay, clay, coffee grounds, activated carbon and water;
forming into shape;
preforming a heat treatment with multiple stages of heating parameters; and
cooling to room temperature by furnace cooling.

9. The application method of a high-efficiency carbon dioxide capture ceramic filtration system according to claim 8, wherein the producing method of the carbon dioxide capture material further comprises calcining the grinded dolomite powder, coral powder, and shell powder by sequential stages of heating parameters at 80° C. for 1 hour, 200° C. for 1 hour, and 1000° C. for 1 hour.

10. The application method of a high-efficiency carbon dioxide capture ceramic filtration system according to claim 8, wherein the producing method of the carbon dioxide capture material further comprises:
mixing the heat-treated dolomite powder, coral powder, and shell powder with the pottery clay, the clay, the coffee grounds and the activated carbon, and adding water;
forming into shape;
performing a heat treatment by sequential stages of heating parameters at 40° C. for 15 minutes to 1 hour, 60° C. for 15 minutes to 1 hour, 80° C. for 30 minutes to 1 hour. 200° C. for 1 hour, and 1000° C. for 1 hour.
